(19) United States
(12) Patent Application Publication
(10) Pub. No.: US 2026/0200380 A1
(43) Pub. Date: Jul. 16, 2026

(54) TAILGATE SEAT SYSTEM

(71) Applicant: GM GLOBAL TECHNOLOGY OPERATIONS LLC, Detroit, MI (US)

(72) Inventors: Erick GOWEN, Macomb, MI (US); Jason ZINK, Rochester Hills, MI (US)

(21) Appl. No.: 19/018,448

(22) Filed: Jan. 13, 2025

(51) Int. Cl. B60N 2/30; B60N 2/75; B62D 33/027

(52) U.S. Cl. CPC B60N 2/3095; B60N 2/3013; B60N 2/78; B62D 33/0273

(57) ABSTRACT

A tailgate seat system including: a tailgate rotatable between a raised position and a lowered position; and a backrest assembly mounted to the tailgate. The backrest assembly includes: a support structure mounted to the tailgate; a back panel mounted to the tailgate by way of the support structure; and armrests mounted to the back panel. The backrest assembly is movable between a stowed position and a deployed position. In the stowed position, the support structure is collapsed and both the back panel and the armrests are coplanar and seated on the tailgate. In the deployed position, the support structure is extended to support the back panel and the armrests spaced apart from the tailgate in a non-coplanar relationship.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a tailgate seat system, such as for a vehicle.

A vehicle tailgate is a hinged rear door of a vehicle. Tailgates are typically included with pickup trucks and some sport utility vehicles (SUVs). The tailgate allows access to a cargo area of the vehicle and can be lowered or opened for loading and unloading items. Tailgates come in various configurations, including traditional drop-down, split, and multi-function types, each offering different features and levels of convenience.

### SUMMARY

The present disclosure provides for, in various features, a tailgate seat system including: a tailgate rotatable between a raised position and a lowered position; and a backrest assembly mounted to the tailgate. The backrest assembly includes: a support structure mounted to the tailgate; a back panel mounted to the tailgate by way of the support structure; and armrests mounted to the back panel. The backrest assembly is movable between a stowed position and a deployed position. In the stowed position, the support structure is collapsed and both the back panel and the armrests are coplanar and seated on the tailgate. In the deployed position, the support structure is extended to support the back panel and the armrests spaced apart from the tailgate in a non-coplanar relationship.

In further features, the tailgate is configured to be mounted to a pickup truck.

In further features, the tailgate is configured to be mounted to a sport utility vehicle (SUV).

In further features, the armrests include cup holders and are mounted to the tailgate by way of the support structure.

In further features, in the lowered position of the tailgate, the backrest assembly is coplanar with a cargo bed of a vehicle to which the tailgate is rotatably mounted to.

In further features, a locking mechanism is included with the back panel of the backrest assembly.

In further features, the locking mechanism includes locking tabs configured to cooperate with the tailgate to retain the backrest assembly in the stowed position, and the locking tabs are configured to cooperate with the support structure to retain the backrest assembly in the deployed position.

In further features, the locking mechanism further includes a latch at a center of the back panel, the locking mechanism is configured such that actuation of the latch pulls the locking tabs inward relative to the back panel to unlock the locking tabs from cooperation the tailgate or the support structure.

In further features, a footrest assembly is mounted to the tailgate.

In further features, the footrest assembly is rotatably mounted to the tailgate and moveable between an extended position and a retracted position, in the retracted position an outermost surface of the footrest assembly is coplanar with the back panel, the armrests, and a cargo bed of a vehicle to which the tailgate is rotatably mounted to.

In further features, the footrest assembly includes a base rotatably mounted to the tailgate and a foot plate rotatably mounted to the base.

In further features, the tailgate defines a recess, the base of the footrest assembly is mounted to the tailgate within the recess, in the retracted position the footrest assembly is folded into the recess, and in the extended position the footrest assembly extends out from within the recess.

The present disclosure also provides for, in various features, a tailgate seat system including: a tailgate rotatable between a raised position and a lowered position; a backrest assembly mounted to the tailgate, the backrest assembly including a back panel mounted to the tailgate and armrests mounted to the back panel; and a footrest assembly rotatably mounted to the tailgate, the footrest assembly including a foot plate. The backrest assembly and the footrest assembly are each independently movable between a stowed position and a deployed position. In the stowed position, the back panel, the armrests, and the foot plate are all coplanar with each other. In the deployed position with the tailgate in the lowered position, the back panel and the armrests are non-coplanar and spaced apart above a top of the tailgate, and the foot plate is unfolded outward below a bottom of the tailgate.

In further features, a support structure mounted to the tailgate. The back panel is mounted to the tailgate by way of the support structure. The support structure is collapsible and configured to support the backrest assembly in both the stowed position and the deployed position.

In further features, in the lowered position, the back panel, the armrests, and foot plate are all coplanar with a cargo bed of a vehicle to which the tailgate is rotatably mounted to.

In further features, a locking mechanism is included with the back panel of the backrest assembly. The locking mechanism includes locking tabs configured to cooperate with the tailgate to retain the backrest assembly in the stowed position, and the locking tabs are configured to cooperate with a support structure to retain the backrest assembly in the deployed position. The locking mechanism further includes a latch at a center of the back panel. The locking mechanism is configured such that actuation of the latch pulls the locking tabs inward relative to the back panel to unlock the locking tabs from cooperation with the tailgate or the support structure.

In further features, the tailgate defines a recess. A base of the footrest assembly is mounted to the tailgate within the recess. In the stowed position, the footrest assembly is folded into the recess. In the deployed position, the footrest assembly extends out from within the recess.

The present disclosure also includes, in various features, a vehicle including a tailgate seat system. The tailgate seat system includes: a tailgate mounted to the vehicle at a rear end of a cargo bed of the vehicle, the tailgate rotatable between a raised position and a lowered position; a backrest assembly mounted to the tailgate, the backrest assembly including a back panel mounted to the tailgate and armrests mounted to the back panel, the armrests including cupholders; and a footrest assembly rotatably mounted to the tailgate, the footrest assembly including a foot plate. The backrest assembly and the footrest assembly are each movable between a stowed position and a deployed position. In the stowed position with the tailgate in the lowered position, the back panel, the armrests, the foot plate, and the cargo bed are all coplanar with each other. In the deployed position with the tailgate in the lowered position, the back panel and the armrests are non-coplanar and spaced apart above a top of the tailgate, and the foot plate is unfolded outward below a bottom of the tailgate.

In further features, the vehicle is a pick-up truck.

In further features, a locking mechanism is included with the back panel of the backrest assembly. The locking mechanism includes locking tabs configured to cooperate with the tailgate to retain the backrest assembly in the stowed position, and the locking tabs are configured to cooperate with a support structure of the back panel to retain the backrest assembly in the deployed position. The locking mechanism further includes a latch at a center of the back panel. The locking mechanism is configured such that actuation of the latch pulls the locking tabs inward relative to the back panel to unlock the locking tabs from cooperation with the tailgate or the support structure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a tailgate seat system in accordance with the present disclosure installed on an exemplary vehicle, the tailgate seat system including a footrest assembly and a backrest assembly mounted to a tailgate, the footrest assembly and the backrest assembly both illustrated in deployed configurations;

FIG. 2 is a side view of the tailgate seat system of FIG. 1 illustrating the tailgate in a lowered position, and the both the backrest assembly and the footrest assembly in stowed positions;

FIG. 3 is a side view of the tailgate seat system of FIG. 1 illustrating the tailgate in the lowered position, the footrest assembly in the stowed position, and the backrest assembly in a partially deployed position;

FIG. 4 is a side view of the tailgate seat system of FIG. 1 illustrating the tailgate in the lowered position, the footrest assembly in the stowed position, and the backrest assembly in a fully deployed position;

FIG. 5 is a perspective view of a support structure of the tailgate seat system of FIG. 1;

FIG. 6 is a side view of the tailgate seat system of FIG. 1 illustrating the tailgate in the lowered position, and both the backrest assembly and the footrest assembly in deployed positions.

FIG. 7 is a side view of the tailgate seat system of FIG. 1 illustrating the tailgate in a raised position, and both the backrest assembly and the footrest assembly in stowed positions;

FIG. 8 is a side view of the tailgate seat system of FIG. 1 illustrating the tailgate in the lowered position, and both the backrest assembly and the footrest assembly in stowed positions;

FIG. 9 is a perspective view of the tailgate seat system of FIG. 1 illustrating the backrest assembly in a stowed position, and the footrest assembly in a partially deployed position; and

FIG. 10 is a plan view of the tailgate seat system of FIG. 1 illustrating a locking mechanism thereof in phantom.

In the drawings, reference numbers may be reused to identify similar and/or identical elements.

### DETAILED DESCRIPTION

The present disclosure provides for a tailgate seat system, such as for a vehicle tailgate. The tailgate seat system of the present disclosure may be configured for use in various non-vehicular applications as well. The tailgate seat system generally includes a backrest assembly with armrests. The backrest assembly is movable between a stowed position and a deployed position. In the stowed position, a back panel and the armrests are flat against the tailgate and coplanar with each other. The back panel and the armrests are also coplanar with a cargo bed (or cargo area) of the vehicle to facilitate sliding of cargo or other items across the tailgate into and out of the vehicle. In some aftermarket applications, however, the back panel and the armrests may not be coplanar with the cargo bed (or cargo area). In the deployed position, a support structure is extended to support the back panel and armrests spaced apart from the tailgate in a non-coplanar relationship. The tailgate provides a seat for one or more persons, and the back panel provides a back support. The tailgate seat system may also include a footrest assembly configured to fold out from the tailgate to support the feet of those seated on the tailgate. The tailgate seat system provides seating in any suitable situation. For example, the tailgate seat system is useful to provide seating during sporting events, tailgate parties, concerts, picnics, camping, work breaks, etc.

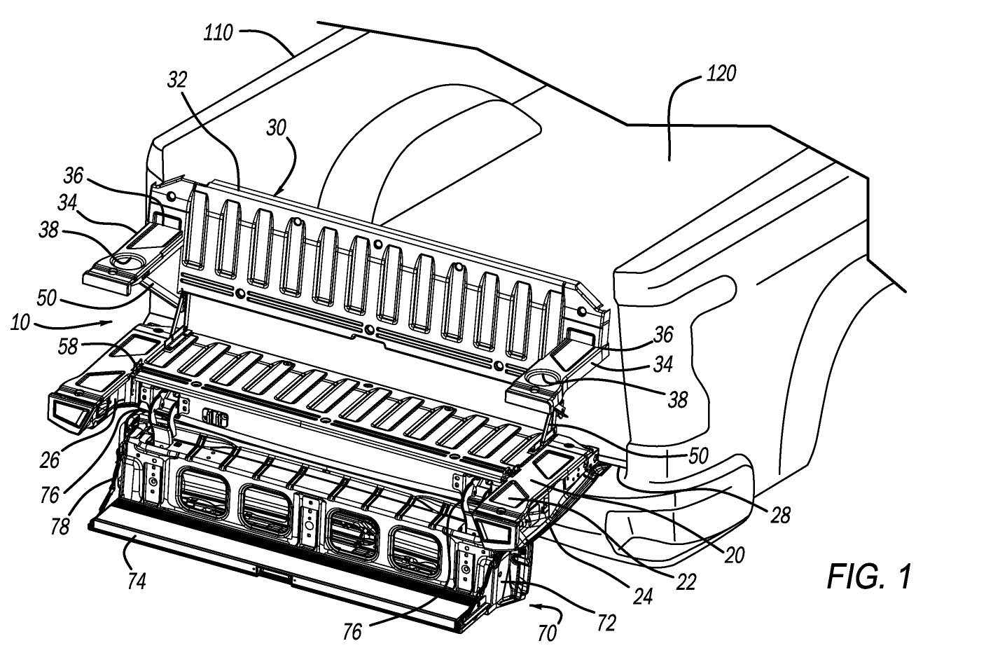

FIG. 1 illustrates a tailgate seat system 10 in accordance with the present disclosure. The tailgate seat system 10 is illustrated as installed on a vehicle 110. The vehicle 110 may be a pickup truck as illustrated, or any other suitable vehicle, such as a sport utility vehicle (SUV) for example. The tailgate seat system 10 may be installed on any other suitable vehicle as well. Further, the tailgate seat system 10 may be configured for use with any suitable non-vehicular application. For example, the tailgate seat system 10 may be installed on any suitable non-vehicular door, gate, panel, etc.

The tailgate seat system 10 generally includes a tailgate 20, a backrest assembly 30, and a footrest assembly 70. The tailgate 20 is configured to be pivotally attached to the vehicle 110 in the form of the pickup truck. The tailgate 20 may be configured to be pivotally attached to any other suitable vehicle or at any suitable non-vehicular location. The tailgate 20 generally includes an inner surface 22 and an outer surface 24. The inner surface 22 is an upper surface when the tailgate 20 is open. The outer surface 24 is a lower surface when the tailgate 20 is open. The tailgate 20 defines a recess 26, which accommodates the footrest assembly 70, as described herein. The tailgate 20 is attached to the vehicle 110 (or to any other suitable vehicle, or to any suitable non-vehicular application) at a tailgate hinge 28.

The backrest assembly 30 includes a back panel 32 with armrests 34 on opposite sides thereof. The back panel 32 provides a backrest of the backrest assembly 30. Each one of the armrests 34 is connected to the back panel 32 at a hinge 36. A cup holder 38 is included with each one of the armrests 34. The cup holders 38 may be configured as recesses or openings on the armrests 34 sized and shaped to accommodate any suitable drink container, or configured in any other suitable manner.

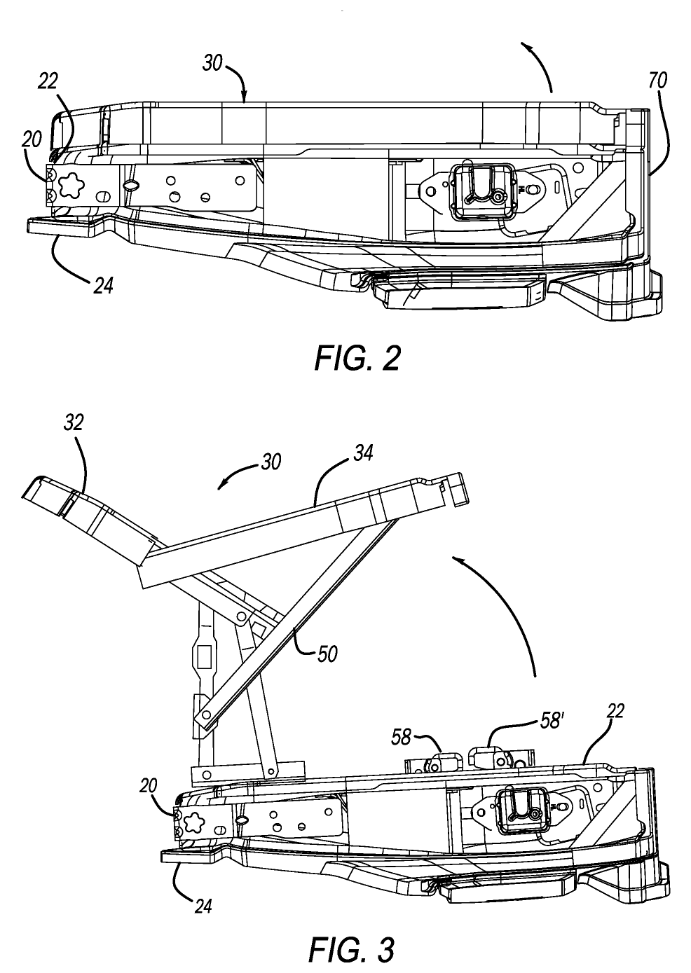

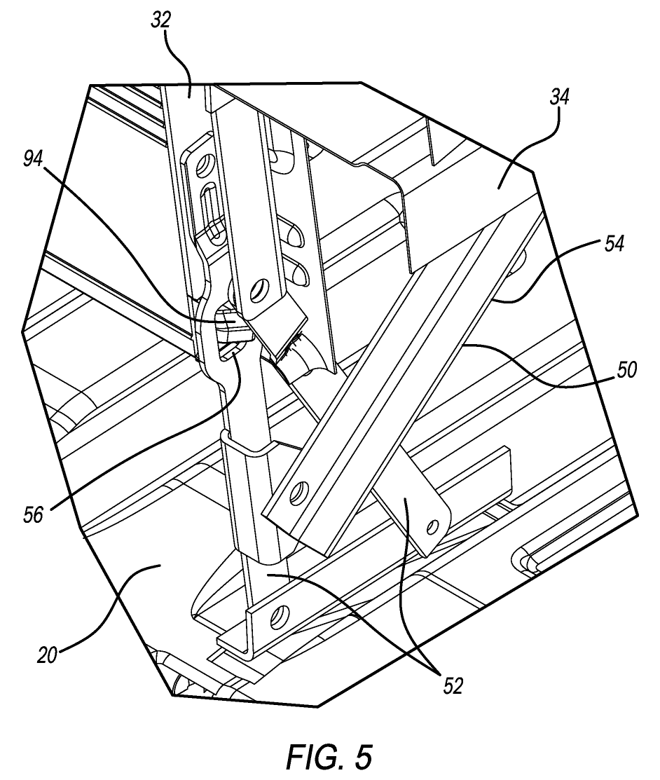

The backrest assembly 30 further includes a support structure 50. The support structure 50 is mounted to the tailgate 20. The back panel 32 and the armrests 34 are mounted to the tailgate 20 by way of the support structure 50. With continued reference to FIG. 1, and additional reference to FIGS. 2-6, for example, the support structure 50 includes first support members 52 and second support members 54. The first support members 52 mount the back panel 32 to the tailgate 20. The second support members 54 connect the armrests 34 to the first support members 52.

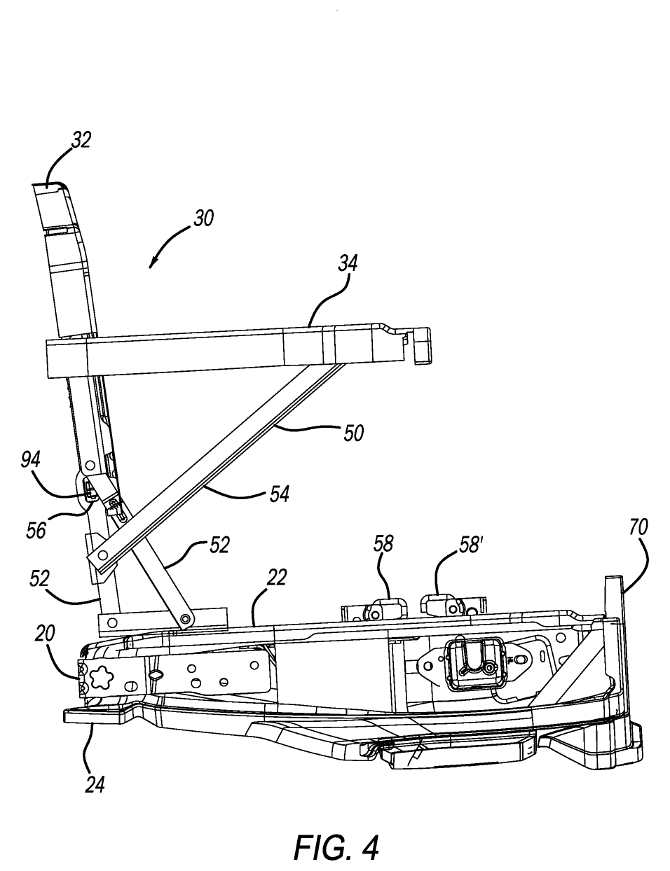

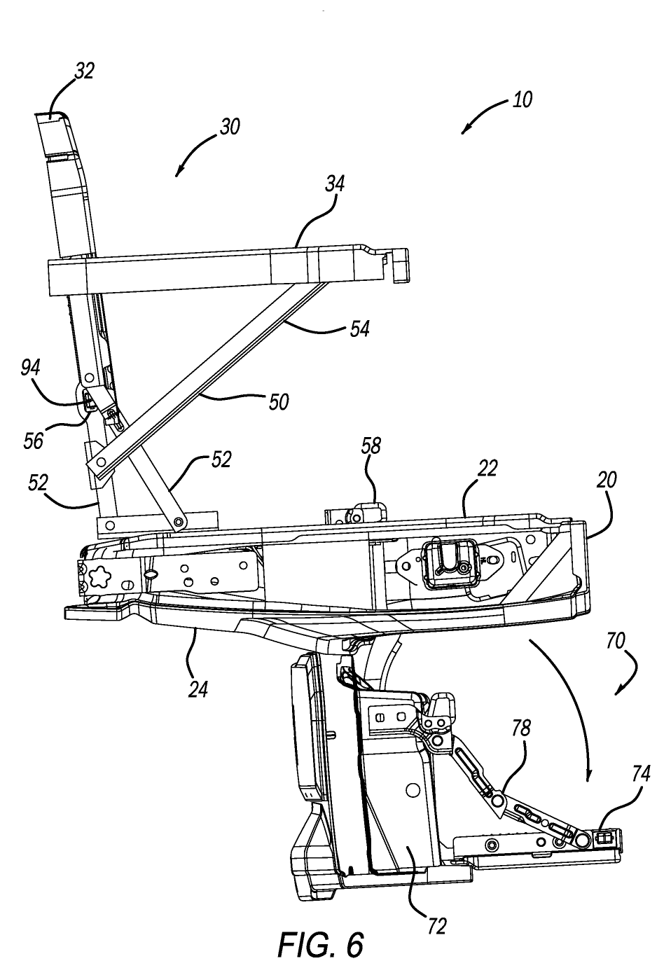

The backrest assembly 30 is movable between a stowed position and a deployed position. The deployed position is illustrated in FIGS. 1, 3 (partially deployed), 4, 5, and 6. The stowed position is illustrated in FIGS. 2 and 7-10. In the stowed position, the support structure 50 is collapsed and the back panel 32 is coplanar with both of the armrests 34. Thus, in the stowed position, the backrest assembly 30 is largely indistinguishable from the inner surface 22 of the tailgate 20. Further, in the stowed position the back panel 32 and the armrests 34 are coplanar with a cargo bed 120 (or other cargo/storage area) of the vehicle 110, which advantageously allows cargo and other items to be easily slid over the backrest assembly 30 into and out of the cargo bed 120. In some aftermarket applications, however, the back panel 32 and the armrests 34 may not be coplanar with the cargo bed 120 (or other cargo/storage area). In the deployed position, the support structure 50 is extended to support the back panel 32 and the armrests 34 spaced apart from the tailgate 20 in a non-coplanar relationship. In the deployed position, such as illustrated in FIGS. 4 and 6, for example, the tailgate 20 provides a seat for one or more persons, the back panel 32 provides back support for those seated, and the armrests 34 provide surfaces (with the cup holders 38) for those seated to rest their arms.

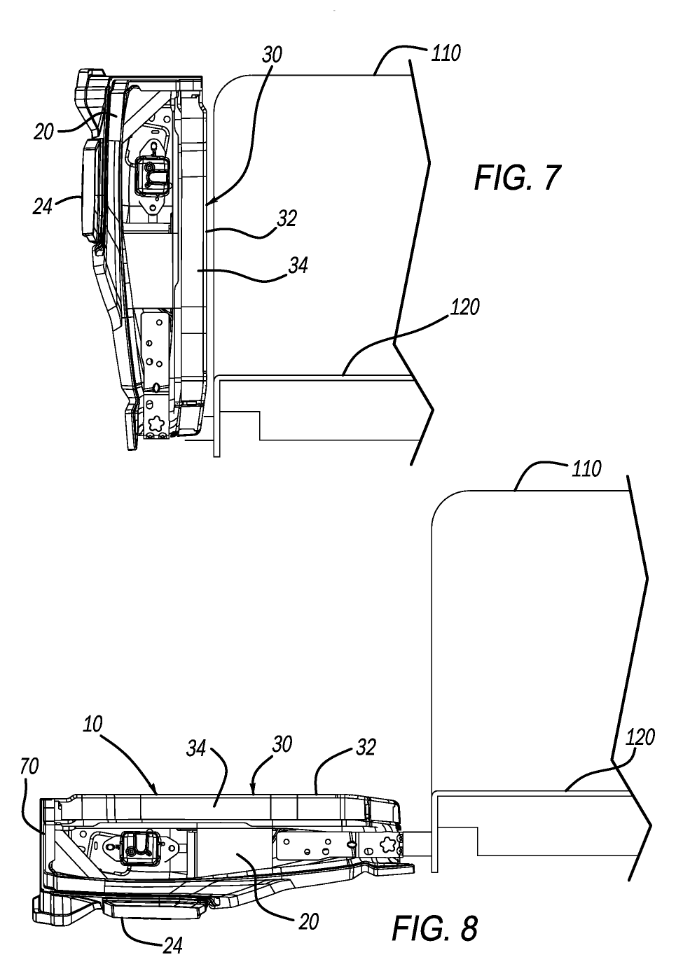

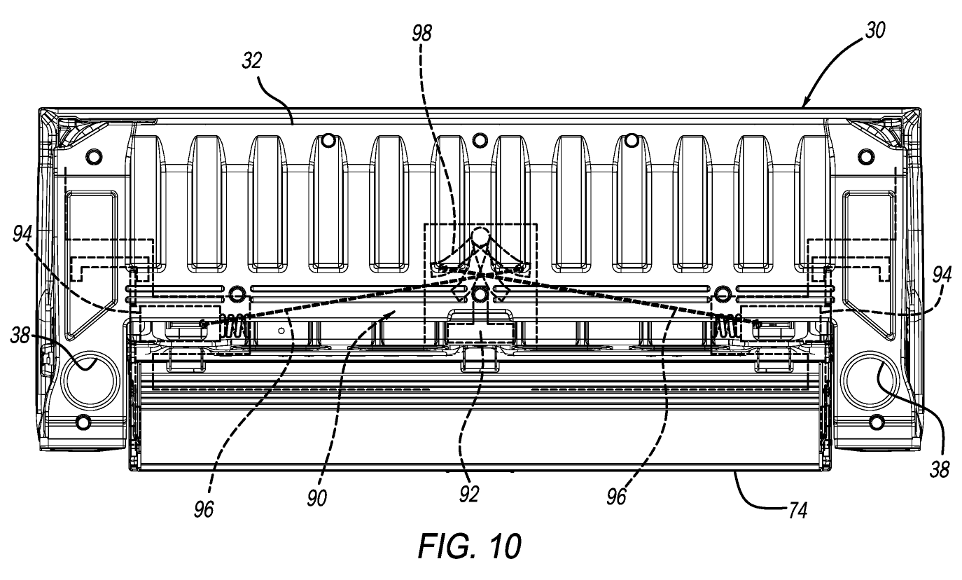

The backrest assembly 30 further includes a locking mechanism 90. With particular referenced to FIG. 10, the locking mechanism 90 includes a latch 92, which may take the form of a handle or button, for example. The latch 92 is connected to tabs 94 by connectors 96. The tabs 94 are biased with springs or any other suitable biasing members to protrude outward beyond sides of the back panel 32. Actuation of the latch 92 moves levers 98, which pull the connectors 96 inward and draw the tabs 94 inward such that the tabs 94 do not protrude from (or only slightly protrude from) the sides of the back panel 32 to effectively unlock the backrest assembly 30. In the stowed position with the support structure 50 collapsed, the tabs 94 are seated within apertures 58 (FIGS. 1, 3, 4, and 6, for example) to lock the back panel 32 and the armrests 34 down onto the tailgate 20. The tailgate 20 may be rotated between a raised position (FIG. 7) and a lowered position (FIG. 8) with the backrest assembly 30 locked in the stowed position.

To unlock the backrest assembly 30 and permit movement of the backrest assembly 30 from the stowed position to the deployed position, the latch 92 is pressed or otherwise actuated, to rotate the levers 98, which draws the connectors 96 and the tabs 94 inward into the sides of the back panel 32. As the tabs 94 are pulled inward, the tabs 94 disengage the apertures 58, which allows the backrest assembly 30 to be raised from the stowed position to the deployed position. As the backrest assembly 30 is raised, the support structure unfolds from the collapsed orientation to the extended orientation. The armrests 34 are connected to the back panel 32 at hinges 36, and connected to the second support members 54 such that as the back panel 32 is raised to the deployed position the armrests 34 fold outward to be non-coplanar to the back panel 32. In some applications, in the deployed position the armrests 34 are at an angle relative to the back panel 32 that is slightly greater than 90°.

When the backrest assembly 30 is raised to the fully deployed position, the tabs 94 lock into apertures 56 defined by the first support members 52 to lock the backrest assembly 30 in the raised position of FIGS. 4 and 6, for example. To move the backrest assembly 30 back to the stowed position, the latch 92 is again pressed or otherwise actuated to draw the tabs 94 back into, or nearly into, the back panel 32. As the tabs 94 are drawn inward, the tabs 94 exit and disengage the apertures 56. With the tabs 94 no longer seated in the apertures 56, the backrest assembly 30 is free to be folded down by a user to collapse the support structure 50 and move the backrest assembly 30 back to the stowed position. In the stowed position, the tabs 94 engage the apertures 58 to lock the backrest assembly 30 in the stowed position.

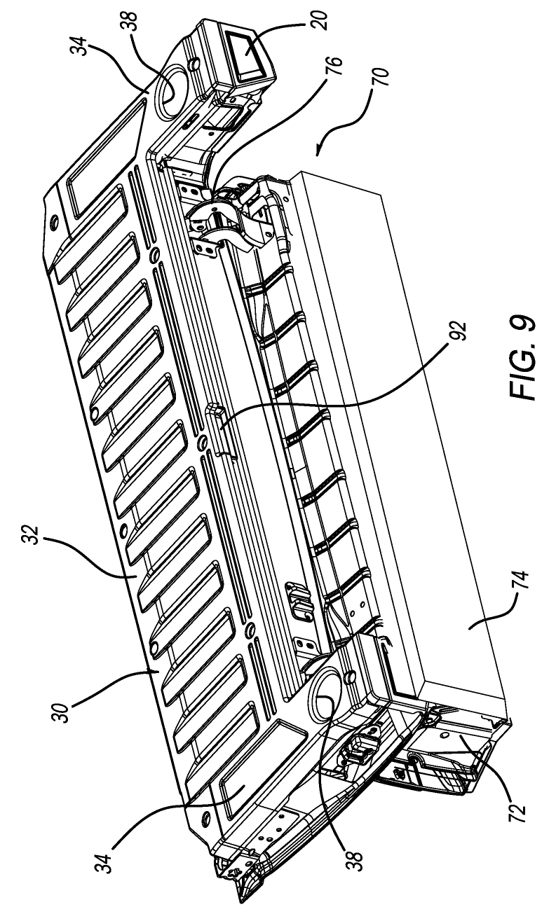

The footrest assembly 70 includes a base 72 and a foot plate 74. The base 72 is mounted to the tailgate 20 with first hinges 76. The foot plate 74 is mounted to the base 72 with second hinges 78. The footrest assembly 70 is movable between a stowed position (FIGS. 2-4, 7, and 8) and a deployed position (FIGS. 1 and 6). FIG. 9 illustrates the footrest assembly 70 in a partially deployed position.

In the stowed position, the footrest assembly 70 is retracted into the recess 26 of the tailgate 20 and arranged such that the foot plate 74 is folded and co-planar with the backrest assembly 30 (see FIGS. 2, 7, and 8, for example). With the foot plate 74 co-planar with the backrest assembly 30, cargo and other items may be slid along the tailgate 20 into and out of the cargo bed 120 without being obstructed by the tailgate seat system 10. To lock the footrest assembly 70 in the stowed position, the footrest assembly 70 may include any suitable locking mechanism. For example, the footrest assembly 70 may include locking tabs similar to the tabs 94 of the back panel 32, which are positioned to cooperate with apertures 58ʹ of the tailgate 20. The footrest assembly 70 may include a latch similar to the latch 92 for locking and unlocking the footrest assembly 70. Once unlocked, the footrest assembly 70 may be unfolded out from within the recess 26 and extended into the deployed position. Specifically, the base 72 is rotated downward below the outer surface 24 of the tailgate 20 about the first hinges 76 out from within the recess 26 of the tailgate 20. And the foot plate 74 is rotated outward from the base 72. The foot plate 74 provides a footrest for a person seated on the tailgate 20.

The backrest assembly 30 and the footrest assembly 70 may each be arranged in their respective deployed or stowed positions independent of each other. For example and as illustrated in FIG. 4, the backrest assembly 30 may be arranged in the deployed position and the footrest assembly 70 may be arranged in the stowed position. As illustrated in FIG. 9, for example, the backrest assembly 30 may be arranged in the stowed position and the footrest assembly 70 may be arranged in the deployed position (although FIG. 9 illustrates a partially deployed position of the footrest assembly 70 with the foot plate 74 not folded outward from the base 72). The footrest assembly 70 is optional, and need not be included with the tailgate seat system 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A tailgate seat system comprising:
a tailgate rotatable between a raised position and a lowered position; and
a backrest assembly mounted to the tailgate, the backrest assembly including:
a support structure mounted to the tailgate;
a back panel mounted to the tailgate by way of the support structure; and
armrests mounted to the back panel,
wherein:
the backrest assembly is movable between a stowed position and a deployed position,
in the stowed position the support structure is collapsed and both the back panel and the armrests are coplanar and seated on the tailgate, and
in the deployed position the support structure is extended to support the back panel and the armrests spaced apart from the tailgate in a non-coplanar relationship.

2. The tailgate seat system of claim 1, wherein the tailgate is configured to be mounted to a pickup truck.

3. The tailgate seat system of claim 1, wherein the tailgate is configured to be mounted to a sport utility vehicle (SUV).

4. The tailgate seat system of claim 1, wherein the armrests include cup holders and are mounted to the tailgate by way of the support structure.

5. The tailgate seat system of claim 1, wherein in the lowered position of the tailgate, the backrest assembly is coplanar with a cargo bed of a vehicle to which the tailgate is rotatably mounted to.

6. The tailgate seat system of claim 1, further comprising a locking mechanism included with the back panel of the backrest assembly.

7. The tailgate seat system of claim 6, wherein the locking mechanism includes locking tabs configured to cooperate with the tailgate to retain the backrest assembly in the stowed position, and the locking tabs are configured to cooperate with the support structure to retain the backrest assembly in the deployed position.

8. The tailgate seat system of claim 7, wherein the locking mechanism further includes a latch at a center of the back panel, the locking mechanism is configured such that actuation of the latch pulls the locking tabs inward relative to the back panel to unlock the locking tabs from cooperation the tailgate or the support structure.

9. The tailgate seat system of claim 1, further comprising a footrest assembly mounted to the tailgate.

10. The tailgate seat system of claim 9, wherein the footrest assembly is rotatably mounted to the tailgate and moveable between an extended position and a retracted position, in the retracted position an outermost surface of the footrest assembly is coplanar with the back panel, the armrests, and a cargo bed of a vehicle to which the tailgate is rotatably mounted to.

11. The tailgate seat system of claim 10, wherein the footrest assembly includes a base rotatably mounted to the tailgate and a foot plate rotatably mounted to the base.

12. The tailgate seat system of claim 11, wherein the tailgate defines a recess, the base of the footrest assembly is mounted to the tailgate within the recess, in the retracted position the footrest assembly is folded into the recess, and in the extended position the footrest assembly extends out from within the recess.

13. A tailgate seat system comprising:
a tailgate rotatable between a raised position and a lowered position;
a backrest assembly mounted to the tailgate, the backrest assembly including a back panel mounted to the tailgate and armrests mounted to the back panel; and
a footrest assembly rotatably mounted to the tailgate, the footrest assembly including a foot plate,
wherein:
the backrest assembly and the footrest assembly are each independently movable between a stowed position and a deployed position,
in the stowed position, the back panel, the armrests, and the foot plate are all coplanar with each other, and
in the deployed position with the tailgate in the lowered position, the back panel and the armrests are non-coplanar and spaced apart above a top of the tailgate, and the foot plate is unfolded outward below a bottom of the tailgate.

14. The tailgate seat system of claim 13, further comprising a support structure mounted to the tailgate, the back panel is mounted to the tailgate by way of the support structure,
wherein the support structure is collapsible and configured to support the backrest assembly in both the stowed position and the deployed position.

15. The tailgate seat system of claim 13, wherein in the lowered position, the back panel, the armrests, and foot plate are all coplanar with a cargo bed of a vehicle to which the tailgate is rotatably mounted to.

16. The tailgate seat system of claim 13, further comprising a locking mechanism included with the back panel of the backrest assembly;
wherein the locking mechanism includes locking tabs configured to cooperate with the tailgate to retain the backrest assembly in the stowed position, and the locking tabs are configured to cooperate with a support structure to retain the backrest assembly in the deployed position; and
wherein the locking mechanism further includes a latch at a center of the back panel, the locking mechanism is configured such that actuation of the latch pulls the locking tabs inward relative to the back panel to unlock the locking tabs from cooperation with the tailgate or the support structure.

17. The tailgate seat system of claim 13, wherein the tailgate defines a recess, a base of the footrest assembly is mounted to the tailgate within the recess, in the stowed position the footrest assembly is folded into the recess, and in the deployed position the footrest assembly extends out from within the recess.

18. A vehicle including a tailgate seat system, the tailgate seat system comprising:
a tailgate mounted to the vehicle at a rear end of a cargo bed of the vehicle, the tailgate rotatable between a raised position and a lowered position;
a backrest assembly mounted to the tailgate, the backrest assembly including a back panel mounted to the tailgate and armrests mounted to the back panel, the armrests including cupholders; and
a footrest assembly rotatably mounted to the tailgate, the footrest assembly including a foot plate,
wherein:
the backrest assembly and the footrest assembly are each movable between a stowed position and a deployed position,
in the stowed position with the tailgate in the lowered position, the back panel, the armrests, the foot plate, and the cargo bed are all coplanar with each other, and
in the deployed position with the tailgate in the lowered position, the back panel and the armrests are non-coplanar and spaced apart above a top of the tailgate, and the foot plate is unfolded outward below a bottom of the tailgate.

19. The vehicle of claim 18, wherein the vehicle is a pick-up truck.

20. The vehicle of claim 18, further comprising a locking mechanism included with the back panel of the backrest assembly;
wherein the locking mechanism includes locking tabs configured to cooperate with the tailgate to retain the backrest assembly in the stowed position, and the locking tabs are configured to cooperate with a support structure of the back panel to retain the backrest assembly in the deployed position; and
wherein the locking mechanism further includes a latch at a center of the back panel, the locking mechanism is configured such that actuation of the latch pulls the locking tabs inward relative to the back panel to unlock the locking tabs from cooperation with the tailgate or the support structure.
